(19) United States
(12) Patent Application Publication
(10) Pub. No.: US 2012/0137238 A1
(43) Pub. Date: May 31, 2012

(54) DATA VISUALIZATION INTERFACE INCLUDING RANGE CONTROL AND TREEMAP INTEGRATION

(75) Inventor: Christian Olaf Abeln, Odakra (SE)

(73) Assignee: MICROSOFT CORPORATION, REDMOND, WA (US)

(21) Appl. No.: 12/955,870

(22) Filed: Nov. 29, 2010

(51) Int. Cl. G06F 3/048

(52) U.S. Cl. 715/771

(57) ABSTRACT

Data visualization features include visual range controls and treemap representation integration, but the embodiments are not so limited. A computer-implemented method of an embodiment provides a visualization interface that includes a treemap visualization and a number of visual range controls to control rendering of the treemap visualization. A system of one embodiment includes integrated histogram-based color and size range control filters to control aspects of a treemap visualization. Other embodiments are included and available.

The patent or application file contains at least one drawing executed in color. Copies of this patent or patent application publication with color drawing(s) will be provided by the Office upon request and payment of the necessary fee.

### BACKGROUND

Important business decisions often revolve around comprehension of complex data sets in the context of some business goal. For example, a company may use database and spreadsheet applications to track profitable and unprofitable assets over a particular calendar year using multidimensional sets of data that may include partner data, customer data, or other information. Advanced data and graphical processing tools enable end-users to visualize aspects of multidimensional attributes and values of the complex data. Video processing methods and rendering programs provide algorithms that can process multiple dimensions of a complex data set as part of rendering a visualization scene. For example, a user may use a visualization when making decisions to avoid undesirable consequences and understand the highly complex nature of the vast numbers of values to track or plot. Data reduction methods can be used to reduce the complex data by creating new dependent variables. For example, sales and expense data can be reduced and visualized in terms of profit or loss which may be more meaningful to the end-user. However, many of the available applications are limited to pre-set interface control types and static user interaction features.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide data visualization features, including visual range controls and treemap representation integration, but the embodiments are not so limited. In an embodiment, a computer-implemented method provides a visualization interface that includes a treemap visualization and a number of visual range controls to control rendering of the treemap visualization. In one embodiment, a system includes integrated histogram-based color and size range control filters to control aspects of a treemap visualization. Other embodiments are included and available.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary system to provide treemap visualizations.

FIGS. 2A-2E depict aspects of an exemplary client-server based visualization environment.

FIG. 3 depicts aspects of an exemplary visualization interface.

FIG. 4 depicts aspects of an exemplary color-based visualization control interface.

FIG. 5 depicts aspects of an exemplary size-based visualization control interface.

FIGS. 6A-6C depict examples of a histogram-based filter control interface.

FIGS. 7A-7B depict examples of a visualization interface including a treemap representation and visual control features.

FIG. 8 depicts a functional block diagram of exemplary computing environment.

FIG. 9 is a flow diagram illustrating an exemplary process of providing a treemap data visualization.

FIG. 10 is a block diagram illustrating an exemplary computing environment for implementation of various embodiments described herein.

### DETAILED DESCRIPTION

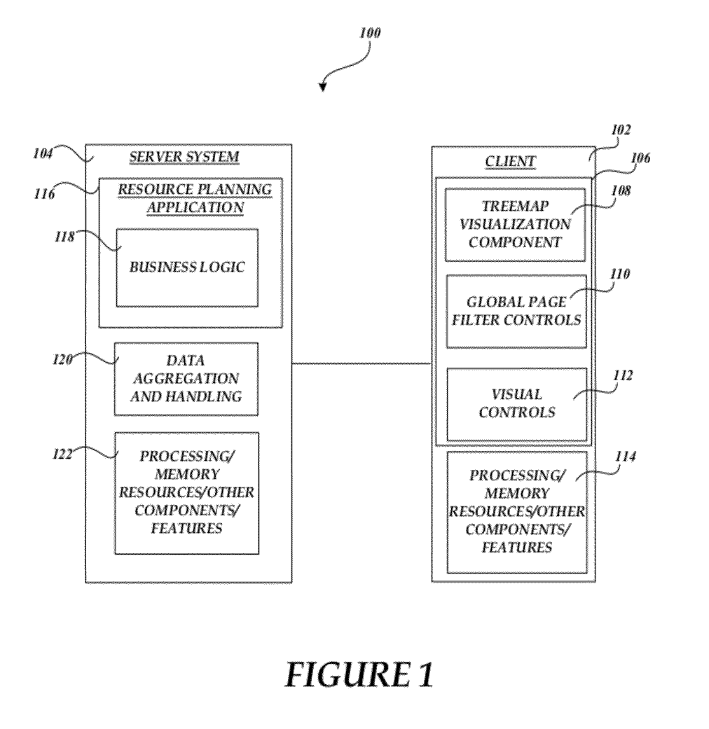

FIG. 1 is a block diagram of an exemplary system 100 that includes data processing, video processing, memory, and/or other components that provide data visualization and other features, but the embodiments are not so limited. As described below, components of the system 100 can operate to provide treemap data visualizations which can be used in conjunction with one or more visual controls to analyze business and other data. For example, components of the system 100 can operate to provide a treemap visualization for analyzing business data by providing insight using different data perspectives to identify data outliers, actionable items, and/or other pertinent visualizations.

In one embodiment, components of the system 100 provide treemap visualizations using data to populate treemap elements or fields and/or entity content, wherein treemap fields can represent data rows as rectangles, which can be further characterized and/or transitioned using size and/or color measures. An interactive treemap visualization can be used to replace a typical list-type representation for customers, including the use of size and/or color features and/or controls to enhance interpretative analysis and other operations.

For example, components of the system 100 can operate to provide an interactive treemap visualization that includes color and size visual controls that can be used to display: values of a color measure mapped to a color gradient which is based on a number of colors, three colors for example, wherein the color gradient transitions algorithmically from color1=blue through color2=gray and to color3=red. The largest value maps to one end of the color range, for example blue; and the smallest value maps to the other end of the color range, for example red. All other values map algorithmically to a respective color in the range. An algorithm may for example be of linear nature, parabolic, exponential or other nature. For a non-numeric color measure, the range can be chopped or sub-divided into discrete color samples. Continuing the example, the interactive treemap visualization can be provided to display customers with: large values of a size measure as large rectangles, small values are displayed as small rectangles, wherein the size range of the rectangles algorithmically increases or decreases with the values of the visualization.

One or more treemap data structures can be used to provide visualization data for display (e.g., values per rectangle in the consumed data) including using a list of possible measure fields (e.g., fields associated with a business data entity) and the currently selected measure fields to populate measure selectors. As described below, the system 100 of an embodiment includes histogram-based visual filtering features integrated with a treemap visualization and underlying business logic. For example, an enterprise can use a resource planning computing architecture to aggregate, organize, and provide insight to business data, including using treemap representations and visual filter controls that can be used to gain insight into aggregated data. In one embodiment, treemap visualization and/or control features can be provided as a program add-in, including a server-side object, a codeunit for data processing, and/or other features.

Exemplary business data visualizations can be used, but are not limited to: picture aspects of a business by providing a mental model for business data and data dependencies using a visual representation; understand fundamentals of a business, including state and trend data using visualizations as an entry point for understanding the current state of a business and trends; drill-down and filter data to provide intuitive, ad hoc analysis; provide knowledge to act (e.g., identify actionable tasks), including identifying items of interest and outliers in business data that are based on certain objectives or measures (e.g., converting certain outliers into high-priority actionable tasks and possible actions); act wisely by providing decision support, problem solvers, and optimization based on a given strategy, including providing suggestions for an action strategy that can lead to an optimal result for one or more objectives; understand consequences using visualizations to understand impacts of actions before committing the action or actions by accounting for dependencies; predict an outcome of a series of actions; etc.

Exemplary use of components of the system 100 can provide treemap visualization interfaces for gaining insight into business data, such as trends and questionable products and/or services by viewing business data from different perspectives and measure states. In an embodiment, a treemap visualization includes a perspective of at least two measurements or measures that define an appearance of size and color for each field of the treemap visualization. As an example, a user can use the treemap visualization and one or more visual filters to efficiently process large sets of data based on size and color. In one embodiment, a treemap visualization interface includes visual filtering features and a data histogram for each selected measurement. A histogram-based visual filter of one embodiment provides an overview of how many data items appear in a range of values defined by a measurement value range.

As described below, users can use intuitive range filtering features to adjust upper and/or lower boundaries for a range of values from which data objects are visualized. With visual filtering, users can see data items disappear or appear dynamically and transition smoothly in size and color. Correspondingly, a user can follow and keep track of dynamic changes for a large number of visual elements simultaneously as part of providing an effective visualization experience. Users can use these visual tools to better understand a set of business objects with the range of values of multiple measurements in an interactive visualization interface. As a result, users can discover unexpected correspondences, while validating data following presumed correspondences.

A treemap visualization interface can be used to identify actionable items and answers to questions, such as identifying: data items that fall out of typical procedures; data items most and/or least important to act on; and/or how an action produces the most and/or least impact as a few illustrative examples. For example, a user can use visual filters to control rendering of a treemap visualization using filtered visualization data. Using the interactive features of the visualization interface, business questions can frequently be answered by looking at outliers of certain presumed correspondences of measurements for various business situations. For example, a visualization interface can be populated with a treemap representation that includes highlighting of outlier-values as part of identifying a proportional impact of a first measure and/or a second measure. That is, the visualization interface can be used to highlight and draw attention to data items that may not typically follow the presumed correspondences and anticipated flow of data. The treemap visualization interface of one embodiment provides direct access to relevant user interface (UI) pages so that users can act on the business data object behind a treemap field or element.

As shown in FIG. 1, the system 100 of one embodiment includes a client computing device or system 102 (referred to as client 102) and a server system 104, but is not so limited. The client 102 of an embodiment includes a visualization interface 106 including a treemap visualization component 108, global page filter controls 110, and visual controls 112. As shown, the client 102 also includes processing and memory resources 114, including a cache for storing treemap data and other information. The client 104 can also include other applications and/or input/output features, such as data processing, video processing, and/or networking features as examples. As described below, the client 104 can interact with the server system 104 and dynamically visualize multidimensional data aggregations including using a visually distinct treemap representation and associated visual controls to control rendering of the treemap representation.

The server system 104 of an embodiment includes a multidimensional data resource planning application architecture. As shown in FIG. 1, the server system 104 of one exemplary embodiment includes a resource planning application 116 including business rules or logic 118, a data aggregation and handling component 120, and/or other components and features 122. For example, the server system 104 can include a number of networked components (e.g., virtual and physical) that can be used to efficiently process and handle data, metadata, and other information using various data sources to provide visualization data to client 102, including processing change information associated with user interactions with a particular treemap visualization, as described below. For example, the server system 104 can receive data changes including changes associated with transferring client local visual filters into application side filters, drill down into data in the treemap visualization, and/or start business application defined transactions on treemap visualization data fields. Various functionalities and features can be combined and further subdivided based in part on a particular visualization implementation.

In one embodiment, data communication between the client 102 and server system 104 uses a data exchange mechanism composed of view descriptions. For example, the server system 104 can use the data exchange mechanism to provide a number of views for a number of business data entities that correspond with current measures defined in part by size and/or color visualizations and variations. As described above, the system 100 of an embodiment provides an interactive interface that enables users to visually analyze and interact with business entity and other data from different perspectives using at least two measures simultaneously in a comparing manner. Exemplary business measures can be included with a visual representation to represent certain classes of application data that carry attributes values of fixed and/or calculated types used in part to value and compare multiple entities. Exemplary business aspects include, but are not limited to: “Customers”, “Forecasts”, “Documents”, “Sales Orders”, “Purchase Orders”, “Production Orders”, “Transfer Orders”, “Items”, “Material reservations”, “Sold items”, “Vendors”, “Suppliers”, “Alternate Sources”, etc. The visual representation translates into a mental model for users when performing certain tasks using data, including the use of visual attributes that provide special allocation, size, and/or color features.

With continuing reference to FIG. 1, the visual controls 112 of an embodiment include interrelated histogram and visual range filtering controls used to impart visual changes to the treemap visualization due to user interactions, such as by using color and/or size animated transitions. For example, a user can user a slider control to adjust boundary locations of endpoints of a visualization range, or move a currently filtered range within the boundaries of the overall range of available data, to use for the treemap visualization based in part on the underlying data and business logic, wherein treemap fields fade in, fade-out, enlarge, reduce, etc. as an endpoint (or endpoints) of a visualization value range is defined and/or re-defined.

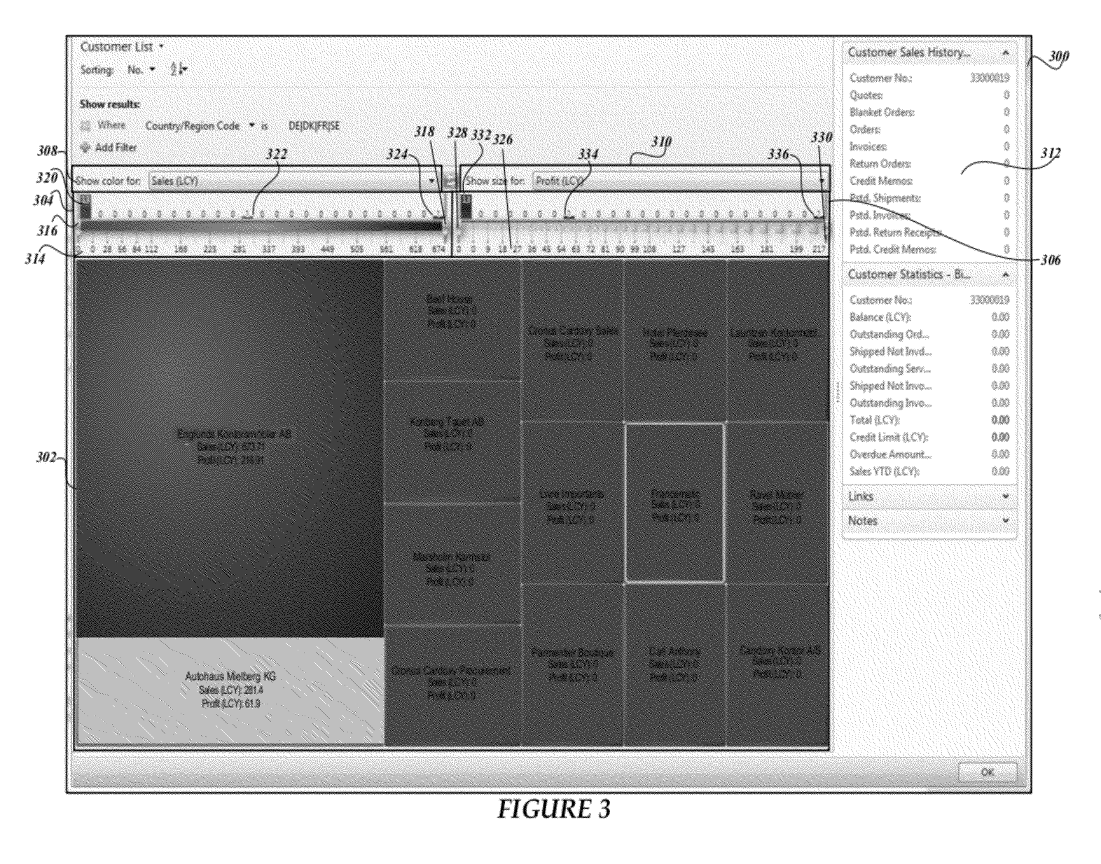

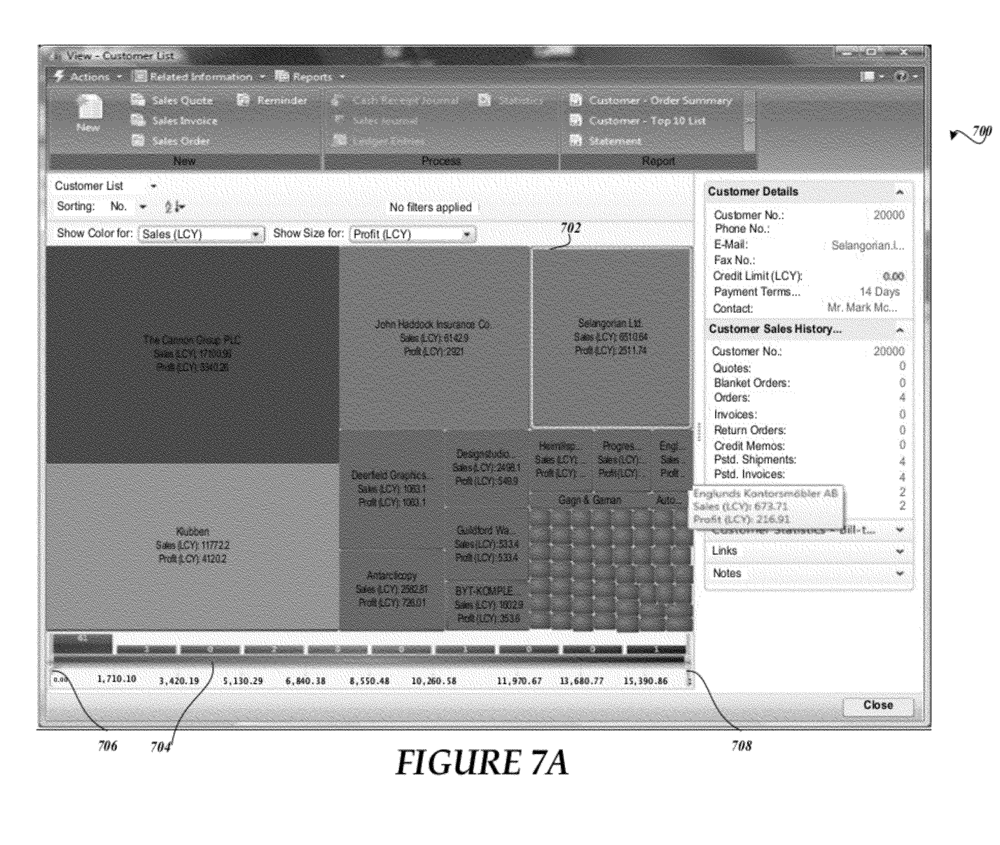

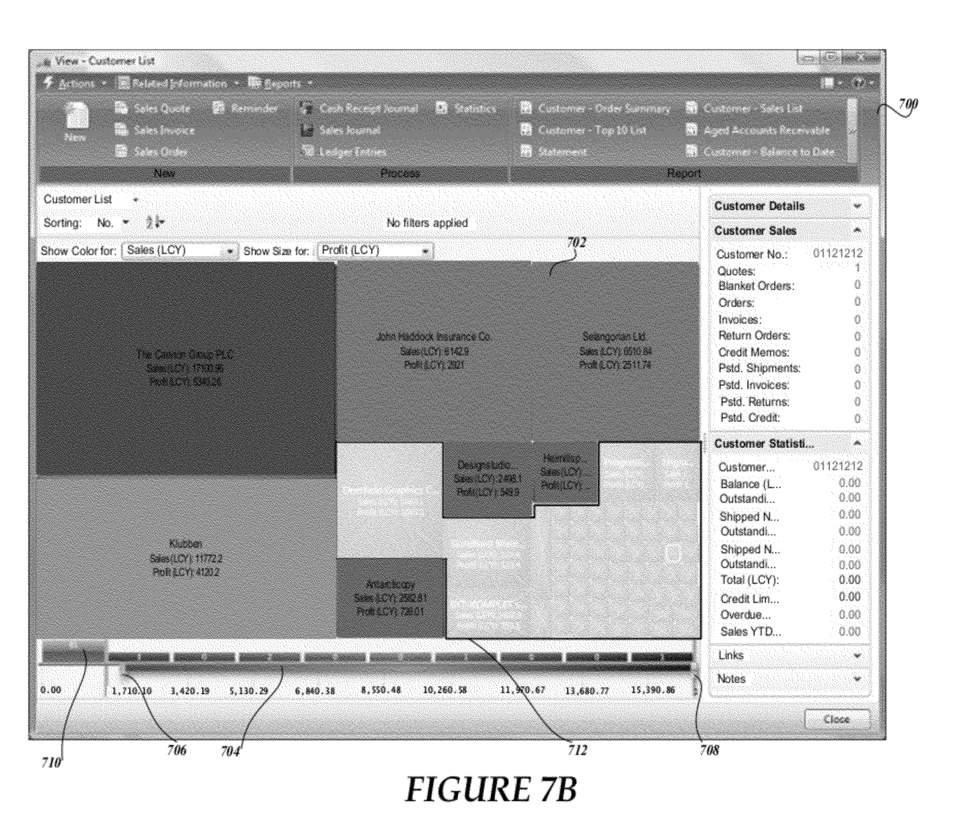

In one embodiment, the system 100 includes interactive histogram and visual range filtering controls disposed adjacently to a treemap visualization (e.g., above, below, right/left, etc.) (see FIGS. 3, and 7A-7B as examples), allowing the user to selectively control visualization data by smoothly transitioning through different actual and/or simulated scenarios, wherein rendering of the treemap elements follows the interactions by responsively changing color and/or size within the treemap visualization display. The user can populate a treemap visualization with data based in part on the use of one or more measure selector controls. For example, a visualization interface can integrate with the global page filter controls 110 that can be used to define a set of entities, whether set by the business logic or defined and/or modified by an end user.

In an embodiment, a histogram data structure can be used to define a histogram representation that splits a value range for an attribute for all entities in a set of sections of the value range. A histogram representation includes range markers that relate the value sections to actual values in the displayed range. Markers can be drawn stronger when a value label is attached. Markers can be drawn light if no value label is attached. If the histogram is drawn for a set of entities that have for the respective attribute values greater than or equal to zero (>=0), then a dedicated value section can be drawn for zero (0) values, if entities exist with a zero attribute value. Such a visualization attracts a user's attention to a business scenario having a special characteristic, which can be identified with a zero (0) value.

In one embodiment, a visual range filter control includes a histogram representation that includes rendering a histogram range column or bar for each section of an overall value range. For a color visual control, the filling of a histogram range column can be rendered with a partial horizontal treemap color gradient (e.g., vertical blue color gradient) that corresponds to a value range that the column represents in the histogram. Filling of a histogram range column can be used to reflect whether a part or all of the entities that correspond to the values in this section of the value range have been filtered out by another visual range filter (e.g., based on size-based visual range filter settings when rendering a color histogram visualization). Each histogram range column renders the number of entities that can correspond to the value section, where the color of the number label in the column can be dynamically selected based on the background or some layer of the number label (e.g., drawing a number label in two colors to correspond with other visual elements of the histogram representation).

In one embodiment, the system 100 includes a dedicated server including a .NET-based Windows Service application that communicates with one or more database servers (e.g., SQL Server databases) and a communication framework protocol to process client requests. In an embodiment, business logic runs on the dedicated server instead of on the client. In another embodiment, client and server components cooperate in accordance with implemented business logic. The dedicated server (e.g., MICROSOFT DYNAMICS server) provides an additional layer of security between visualization clients and any data sources, such as a database server or servers for example. For example, a user can change a measure (e.g., profit, loss, sales, etc.) using a dropdown list to fire a “measures changed event” to the dedicated server as part of updating a treemap data structure with fresh data for selected fields. Interacting with a treemap field (e.g., double-click, pressing ENTER/SEND in the currently selected field), fires a treemap field activated event that opens a corresponding task page for the record underlying the selected treemap field, including the associated page synchronizing fact boxes with a selected record associated with the treemap field.

In one embodiment, the system 100 use a data format for visualization presentations that uses an extensible markup language (XML) definition. For example, a data builder feature (e.g., .NET) can be used by integration code to build the data in a strongly typed way. In such an embodiment, the visualization controls provide for selection and activation of an item, including selection of different visualization measures using color and/or size presentation features and controls. The integration code can handle events and provide new data when necessary. For example, an extensible application markup language (XAML) control can be used by the integration code to control aspects of a data visualization when a different measure has been selected for control with one or more visual filtering controls.

An exemplary computing system includes suitable programming means for operating in accordance with a method of providing a visualization interface and controls interacting with data. Suitable programming means include any means for directing a computer system or device to execute steps of a method, including for example, systems comprised of processing units and arithmetic-logic circuits coupled to computer memory, which systems have the capability of storing in computer memory, which computer memory includes electronic circuits configured to store data and program instructions. An exemplary computer program product is useable with any suitable data processing system. While a certain number and types of components are described above, it will be appreciated that other numbers and/or types and/or configurations can be included according to various embodiments. Accordingly, component functionality can be further divided and/or combined with other component functionalities according to desired implementations.

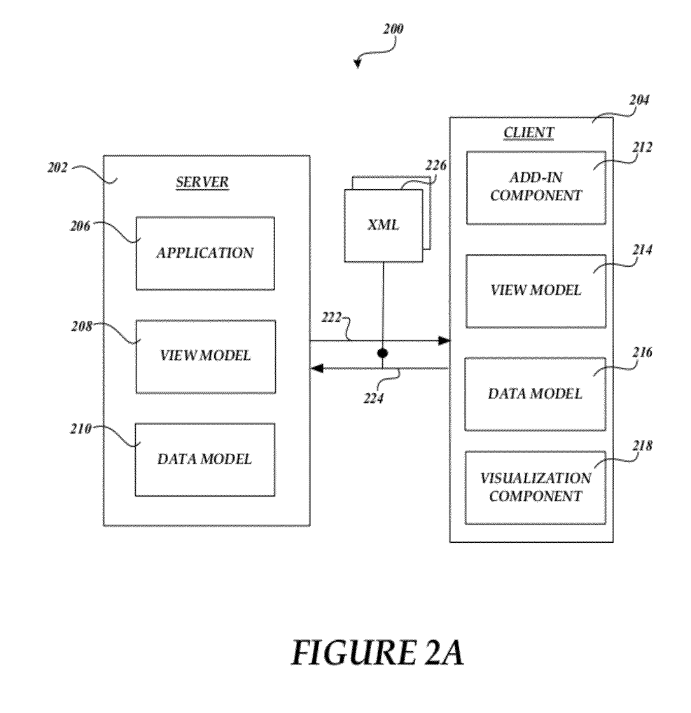

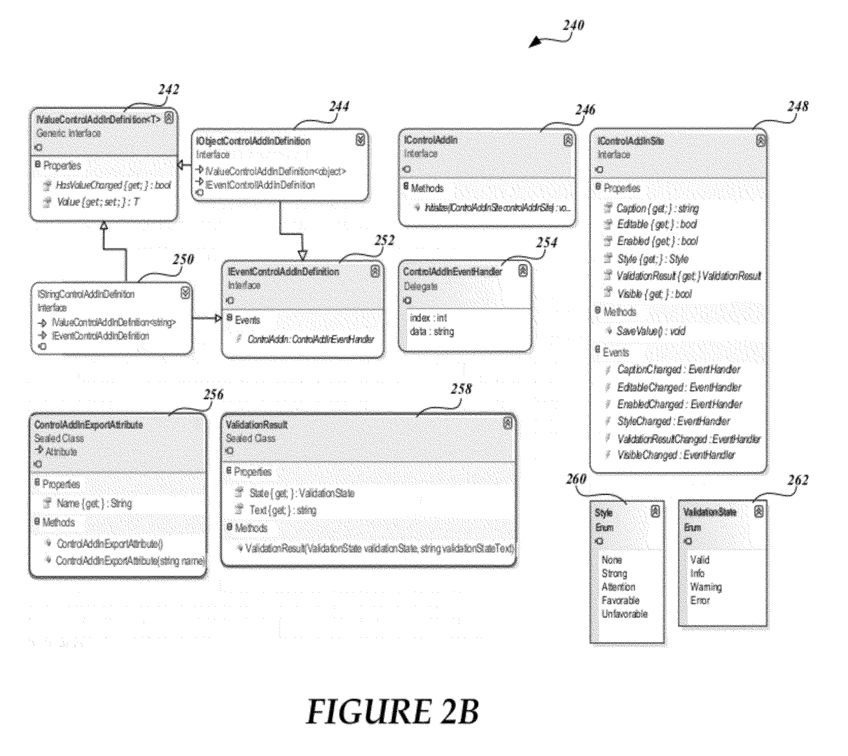

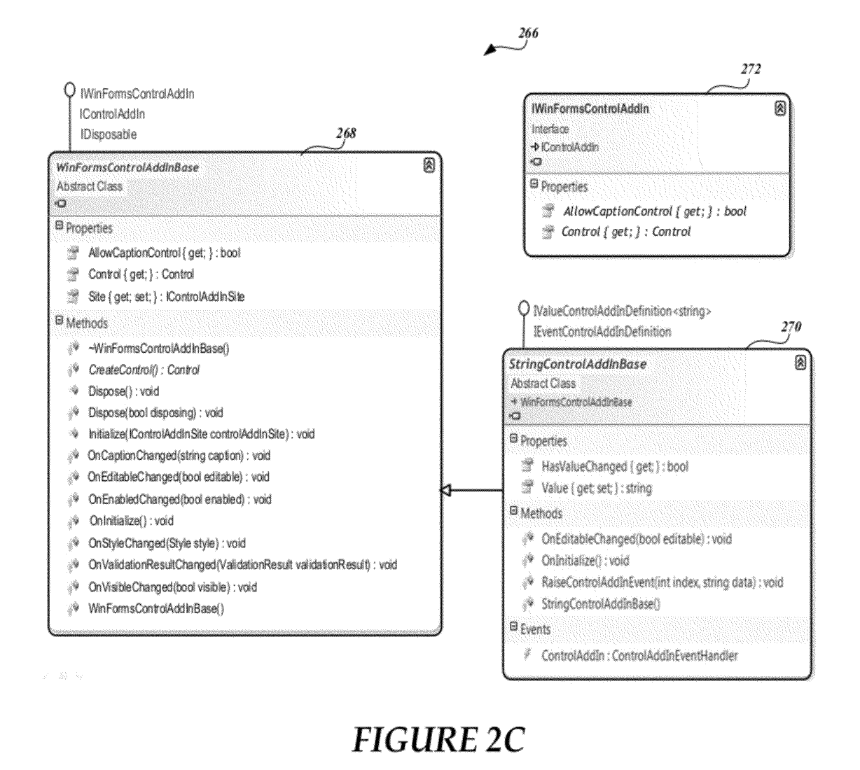

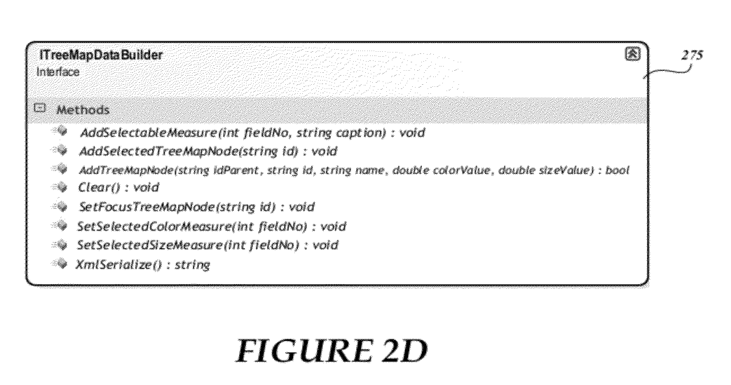

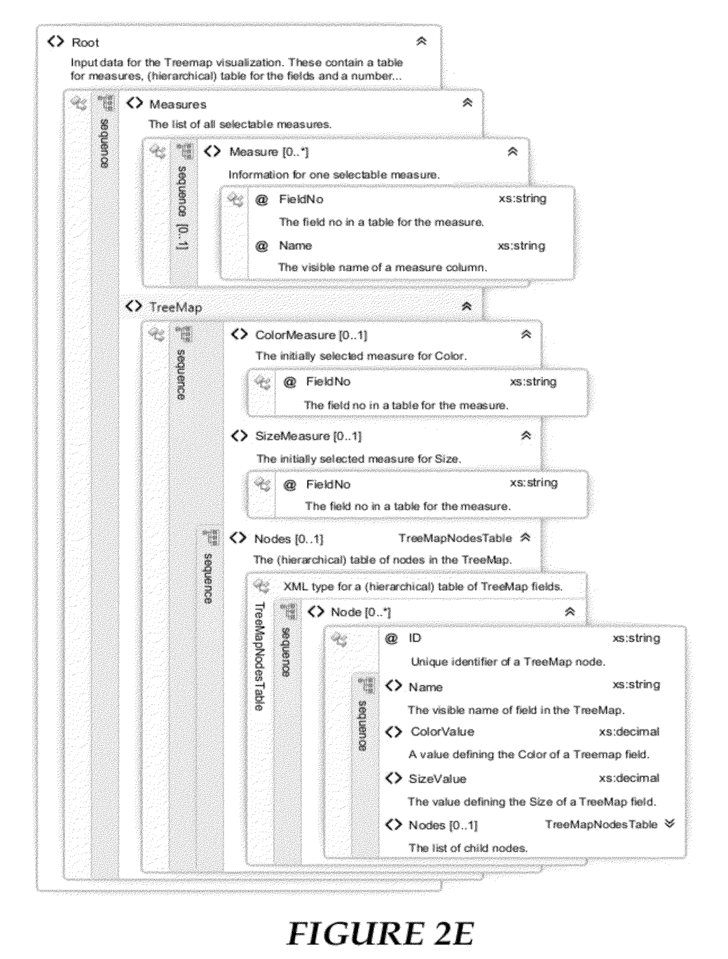

FIGS. 2A-2E depict aspects of an exemplary client-server based visualization environment 200. In an embodiment, the environment 200 includes a treemap data engine and a treemap layout engine. The treemap data engine includes internal logic that works intelligently with received and other data. In one embodiment, when the treemap data engine receives new data, it identifies the new data as an update of data already received. The treemap data engine then identifies that fields for certain data rows that have fallen out of the data sets and fades and shrinks associated treemap fields or portions out of the associated treemap visualization. At the same time, the treemap data engine identifies data rows that came into the visualization as a result of the new data set and creates new treemap fields that fade in and grow into an associated treemap visualization in an animated manner, while the treemap layout engine recalculates the treemap layout of all fields as part of visualizing proportional measure comparisons.

As shown in FIG. 2A, the environment 200 include various components, including a server 202 and a client 204, used in part to provide an interactive visualization experience, but is not so limited. In an embodiment, the server 202 includes an application 206, such as a resource planning application for example, a view model 208, and a data model 210 used in part as a data building system or data builder. The client 204 of this embodiment includes add-in component 212, view model 214, data model 216, and visualization component 218. According to one embodiment, the client 204 includes an add-in library and the server 202 includes a data builder, communicating over a communication channel that includes ports 222 and 224 (e.g., XML port(s) and a .NET data set(s)), using XML data and schema information 226 (shown as XML). The use of one or more XML ports provides a mechanism to provide a communication channel using XML constructs, enabling a server side declaration of an associated visualization model. Correspondingly, visualization driven data documents can be composed and consumed using ports 222 and 224.

As described above, components of the environment 200 can be used to provide a data visualization interface, including an interactive treemap representation designed to be reusable in multiple application scenarios. For example, an interactive treemap representation can be provided to an end-user using one or more resource planning applications to deliver a defined data, command, and event model. In one embodiment, a resource planning or other application and/or system can include integration code to host a visualization in an associated user interface (UI) that communicates transaction data, and receives and processes changes, including updated changes applied in an associated visualization.

In an embodiment, environment 200 includes a set of application objects that implement data communication over XML ports, removing a need for server side extension objects to impart data handling. Integration objects contain logic that aggregates transaction events and populates a visualization data model. The integration objects also contain logic used to receive updated changes and apply the changes to respective business transactions. In one embodiment, the visualization add-in component 214 can be configured to receive documents in XML format using a schema contract defined in part by the add-in code to support command and data documents, but is not so limited. In one embodiment, the environment 200 uses a data document that contains information influencing the view and the table of events visualized along a treemap representation, and/or a command document that contains one or more of the commands that a visualization understands to control of aspects of a treemap visualization. The visualization add-in operates to communicate events to a host using a trigger (e.g., OnControlAddIn trigger). Each event can be characterized by a message ID that characterizes the type of event and contains further string data that provides context information used to process the event, but is not so limited.

FIG. 2B is a functional block diagram of a number of exemplary components of environment 200 as part of providing a visualization interface. As shown, an exemplary application programming interface (API) architecture 240 is shown that includes a number of interactive components. In one embodiment, the various exemplary interfaces 242-262 can be configured as public APIs of environment components for use in part to integrate the various visualization features into further application and personal/particular business setting/particular user setting (finance, health, inventory, yearly prognosis, etc.) scenarios.

As shown in the example, the API architecture 240 of one embodiment includes a generic or base interface 242 (ivaluecontroladdindefinition) for a control add-in definition that binds a control add-in with various data types (e.g., System.String or System.Object data types to a database). Interface 244 (iobjectcontroladdindefinition) is a base interface for a control add-in definition interface that binds the control add-in with a data type (e.g., System.Object) and raises a control event (e.g., Microsoft.Dynamics.Framework.UI.Extensibility.ControlAddInEventHandler event).

Interface 246 enables the control add-in to call the visualization framework (e.g., MICROSOFT DYNAMICS computing architecture) to get additional information about the control add-ins behavior. Interface 248 (e.g., IControlAddInSite) allows a control add-in to get information about a container of the add-in control. Interface 250 (e.g., istringcontroladdindefinition) is a base interface for a control add-in definition interface with a string value type and a specific event (e.g., ControlAddInEventHandler). Interface 252 (e.g., ieventcontroladdindefinition) is a base interface for a control add-in definition interface that defines a specific event (e.g., ControlAddInEventHandler event). Delegate 254 (e.g., controladdineventhandler) specifies a control add-in event. Sealed class 256 (e.g., controladdinexportattribute) is used to declare a class to be a control add-in that can be used in the client 204. Sealed class 258 (e.g., validationresult) is used to represent a result returned by a validation method (e.g., ValidationRule.Validate method) that indicates whether a checked value passed the validation rule.

The API architecture 240 of the example shown in FIG. 2B also includes style and validation state parameters 260 and 262, respectively, each including an enumeration of values that represent certain visualization states (e.g., if validation state is T/F then action or action/if style state is X then perform action Y, etc.). As shown in FIG. 2B, and in accordance with an embodiment of the environment 200, classes and interfaces are independent of a display target or client.

FIG. 2C is a functional block diagram of a number of exemplary components of environment 200 as part of providing the visualization interface. As shown, an exemplary API architecture 266 is shown that includes a number of interactive components. As shown in FIG. 2C, and in accordance with an embodiment of the environment 200, classes and interfaces are configured for a specific target, such as a RTC/WinForms display target for this example.

As shown, abstract class 268 (e.g., winformscontroladdinbase) is a base class for a WINDOWS forms control add-in as an alternative to the explicit implementation of the IWinFormsControlAddIn interface. Abstract class 270 (e.g., stringcontroladdinbase) is a base class for a WINDOWS forms control add-in that binds System.String type data with the database and uses events to call the OnControlAddin trigger on RoleTailored client page controls. Interface 272 (e.g., iwinformcontroladdin) can be used to develop control add-ins that target WINDOWS forms—based displays, including implementing the interface explicitly and overriding its members, or using WinFormsControlAddInBase or StringControlAddInBase abstract base classes that automatically implement the interface.

FIG. 2D depicts an exemplary interface 275 used as part of providing an interactive treemap visualization. In one embodiment, a treemap visualization add-in component uses a variant of data communication associated with server side data builder components. As an example, one or more data builder components can be exposed as a command (COM) object to server side application language (AL) code. A data builder component can be used to expose interface 275 that relieves AL code from having to manually build an XML document.

A data builder component of one embodiment can be used to provide the interface 275 as an API that includes a number of convenience methods that assist with setting data and generating XML for use in generating a treemap visualization using visualization component 218. A number of exemplary methods are shown in FIG. 2D. As shown in FIG. 2D, the methods include, but are not limited to: a method that adds a selectable measure on a treemap builder implementation; a method that adds a treemap node to selected nodes; a method that adds a node to the treemap data under a parent node; a method that removes all data from a treemap builder implementation; a method that sets the currently focused treemap node by ID; a method used to set the field number of a current color measure; a method used to set the field number of a current size measure; and/or a method that serializes data content into an XML string.

FIG. 2E depicts a schema data structure used to define an internal data document as part of providing an interactive treemap visualization.

FIG. 3 depicts aspects of an exemplary visualization interface 300. As shown, the visualization interface 300 of an embodiment includes a treemap representation 302, a first visual control interface 304, a second visual control interface 306, a first measure control 308, a second measure control 310, and a details area 312. For example, the visualization interface 300 can be used in a client server operational architecture, wherein a client can operate to display data visualizations based in part on data sets provided by a serving computer.

The first visual control interface 304 of this example provides color based control features including a color spectrum spanning a first visualization range 314 defined in part by first adjustable boundary control 316 and second adjustable boundary control 318. For this example, the spectrum is defined as a three-color gradient from the color red on the left side of the spectrum display to the color blue on the right side of the spectrum display, transitioning through gray in the center. As shown, the first visualization range 314 includes values for sales (e.g., least to most) as defined by the first measure control setting and first visual control interface 304.

For this example, the first visual control interface 304 includes histogram elements 320, 322, and 324 rendered in the color of the corresponding treemap elements of the treemap representation 302 and are displayed above the spectrum portion or segment along with numerical values that identify the number of entities (e.g., customers) associated with each sales value range. Color renderings of treemap elements of the treemap representation 302 are tied to corresponding color portions or segments of the color spectrum control. Correspondingly, due in part to the visualization features, the user immediately notices that thirteen entities are associated with histogram element 320 having zero “0” sales.

As described above, the zero “0” histogram block can be a key indicator of a particular situation. For example, the zero histogram block may represent some factual scenario that dramatically affects the bottom line of a particular product and/or service. If the user moves first visual control interface 304 to a different value range, selects a different measure, and/or adjusts one or more of the first adjustable boundary control 316 and second adjustable boundary control 318, the treemap elements of the treemap visualization dynamically change colorations according to the spectrum implementation, boundary points, and histogram bin parameters.

The second visual control interface 306 of this example provides size based control features including a size spectrum spanning a second visualization range 326 defined in part by first adjustable boundary control 328 and second adjustable boundary control 330. For this example, the size spectrum increases in size traveling left to right on the control. As shown, the second visualization range 326 includes values for profit (e.g., least to most) as defined by the second measure control setting and second visual control interface 306. For this example, the second visual control interface 306 includes a histogram elements 332, 334, and 336 displayed above the size spectrum along with numerical values that identify the number of entities (e.g., customers) associated with each profit value range. Size renderings of treemap elements of the treemap representation 302 are tied to corresponding portions or segments of the size control. Due in part to the visualization features, the user immediately notices that thirteen entities are associated with histogram element 332 having zero “0” profit.

As described above, the zero “0” histogram block can be a key indicator of various situations/data instantiations. Due to the encoded couplings between rendering parameters of histogram elements, treemap elements, and visual controls, thirteen (13) treemap elements are simultaneously sized with the same rendering size corresponding to the spectrum size associated with histogram element 332 as shown in FIG. 3. If the user moves second visual control interface 306 to a different value range, selects a different measure, and/or adjusts one or more of the first adjustable boundary control 328 and second adjustable boundary control 330, the treemap elements of the treemap visualization dynamically change in size according to the size spectrum implementation, boundary points, and histogram bin parameters.

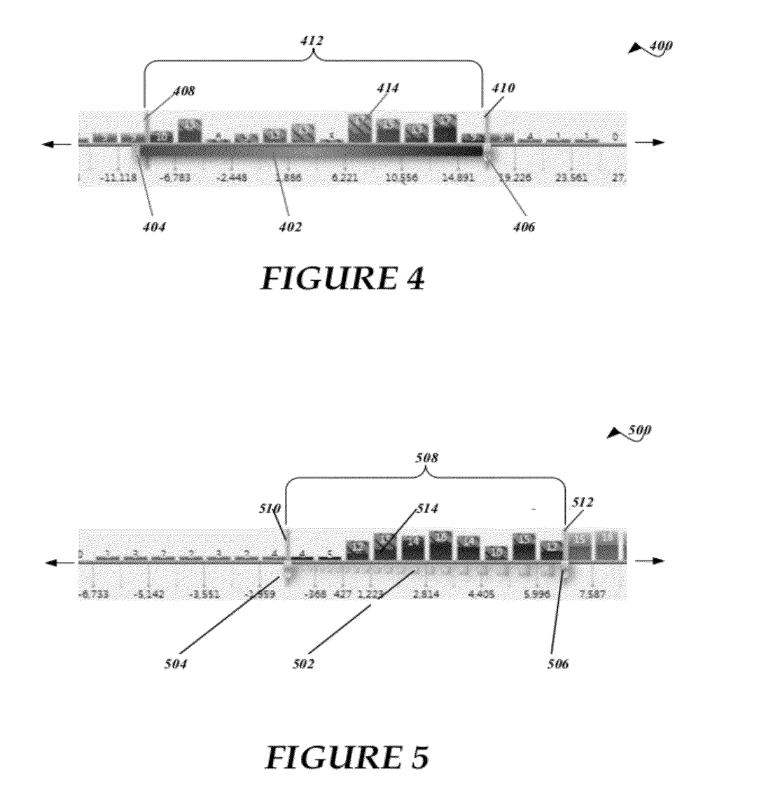

FIG. 4 depicts aspects of an exemplary color-based visualization control interface 400. As shown, the visualization control interface 400 of an embodiment includes color animation control features. As described above, the color animation control features can be tied to a treemap visualization such that rendered treemap elements dynamically update colorfill characteristics and/or fade-in/fade-out operations based in part on control inputs using the visualization control interface 400 and a visualized data set controlled in part by boundaries of a color gradient. Correspondingly, while adjusting an overall range, the configured treemap color gradient updates in the histogram bars, wherein the full color range is rendered as a horizontal gradient in the space between defined sliders to relate the treemap color range to the histogram value ranges currently in the filter.

The visualization control interface 400 of this example provides color-based control features including treemap color gradient control using a color gradient 402 defined in part by first adjustable slider 404 and second adjustable slider 406 with respect to a range of data values. For this example, the spectrum is defined as a three-color gradient of red to blue, transitioning through gray. Markers 408 and 410 delineate values of range endpoints or boundaries for color filter operations. As shown in this example, bounded histogram elements 412 (based on markers 408 and 410) are rendered in the color of the covered color sub-range of color gradient 402.

As shown as one example, histogram bar 414 has seventeen associated entities and is partially cross-hatched to indicate that the range is filtered by another filter. Histogram bars for value sections that are not in the range filter belonging to that same histogram can be drawn in a gray vertical gradient, instead of a horizontal color gradient that corresponds to a partial color range of the treemap elements as shown in the example of FIG. 4. Displayed treemap elements or fields would also display the associated color defined by the corresponding sub-range.

In one embodiment, each field has a color picked from a configurable linear gradient. The default gradient is starting from color 1 (“#FF0000E2”), transitioning through gray tone color 2 (“#FF919191”) at 50% and then to color 3 (“#FFFF0000”). The color gradient can be mapped to values of the color measure such that the lowest value maps to “color 1”, the largest maps to “color 3” and all other values map to the color in the range by linear proportion. An exemplary treemap field can be rendered using a rectangle with a 0.3 X and Y radius and filled with a radial gradient with an origin offset (0.3, 0.3) of radius (2,2) and colors “#4CFFFFFF” and “#66000000” at offset 0.5. The field color will be tuned to the color from the color measure field by setting the background color.

As shown in FIG. 4, each histogram bar includes a numerical value to identify the number of entities associated with the value range defined in part by the width of the bar. FIG. 4 also depicts adjustment of first adjustable slider 404 since marker 408 has not been reset. While the user is moving the sliders, the treemap representation is transitioning the visualization content in an animated way to a state that indicates which treemap fields may be affected in a given way, once the user completes a visual filtering activity or operation.

If the user moves visualization control interface 400 (e.g., right click to grab and move) to a different value range, selects a different measure, and/or adjusts one or both of the adjustable sliders 404, 406, the treemap elements of the treemap visualization dynamically change colorations according to the gradient implementation, boundary points, and/or histogram bin parameters. Cross-hatching or some other visual rendering can be used to delineate portions of histogram elements filtered out by some other filter, a size range filter for example (see for example FIG. 5). For example, as shown in FIG. 4 cross-hatching representations can be rendered within histogram bars to delineate that certain portions of a data set have been filtered by another filter.

FIG. 5 depicts aspects of an exemplary size-based visualization control interface 500. As shown, the visualization control interface 500 of an embodiment includes size animation control features. As described above, the size animation control features can be tied to a treemap visualization such that rendered treemap elements dynamically update size characteristics based in part on control inputs using the visualization control interface 500 and a visualized data set. Correspondingly, while adjusting an overall range, the configured treemap size gradient updates in the histogram bars.

The visualization control interface 500 of this example provides size-based control features including treemap element size control using a size legend 502 defined in part by first adjustable slider 504 and second adjustable slider 506 with respect to a range of data values. For this example, the legend is shown as a number of histogram representations increasing in size from left to right. Correspondingly, larger histogram and treemap element renderings are associated with larger values of the data set.

Markers 510 and 512 delineate values of range endpoints or boundaries for size filter operations. As shown in this example, bounded histogram elements 508 (based on markers 510 and 512) are rendered with cross-hatching and/or color features, including values associated with entities of each histogram bar. Displayed treemap elements or fields would be sized in the treemap visualization as defined by the corresponding sub-range of the size filter. As shown, each histogram bar includes a numerical value to identify the number of entities associated with the value range defined by the width of the bar. As one example, histogram bar 514 has fifteen associated entities and is partially cross-hatched to indicate that the range is filtered by another filter (e.g., the visual filter of FIG. 4). For this example, the bounded histogram elements 508 are colored with a common color scheme (e.g., vertical blue gradient).

While the user is moving the sliders, the treemap representation is transitioning the visualization content in an animated way to a state that indicates which treemap fields may be affected in a given way, as soon as the user completes a visual filtering activity or operation (e.g., releasing a mouse control). As an example, if due to the range filter operation entities will fall out of a current treemap visualization (e.g., the fields will be hidden based on the operation), the treemap representation can render these fields grayed with a light cross.

Continuing the example, if due to the range filter operation entities will come in to the current treemap visualization (e.g., the fields will be shown based on the operation), the treemap representation can add the respective fields to the layout as grayed elements. Once a filter operation is complete (e.g., user has released control of a slider), the treemap representation will fade in new fields added to the updated treemap visualization and fade out filtered fields that have fallen out due to the filter operation(s). Treemap visualization includes smooth filtering features to smoothly transition between state changes of rendered treemap elements.

If the user moves visualization control interface 500 to a different value range, selects a different measure, and/or adjusts one or both of the adjustable sliders 504, 506, the treemap elements of the treemap visualization dynamically change in size according to the size control implementation, boundary points, and/or histogram bin parameters. Cross-hatching or some other visual rendering can be used to delineate portions of histogram elements filtered out by some other filter, a color range filter for example (see for example FIG. 4). For example, as shown in FIG. 5 cross-hatching representations can be rendered within histogram bars to delineate that certain portions of a data set have been filtered by another filter.

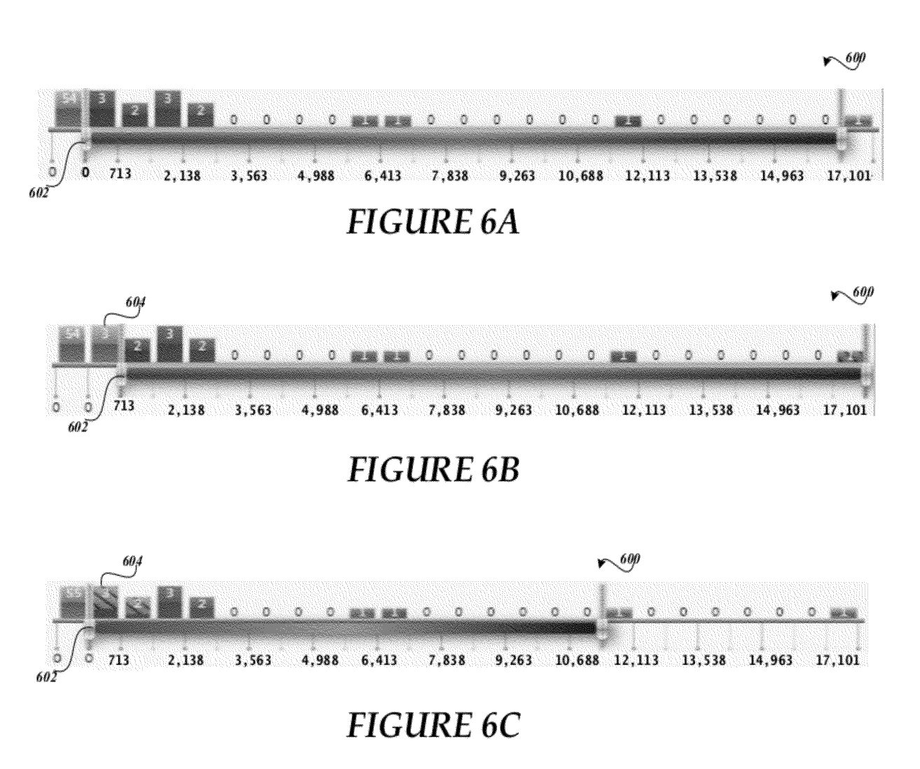

FIGS. 6A-6C depict examples of a histogram-based filter control interface 600 as a user manipulates a slider control 602. FIG. 6A depicts the control 602 at an initial location that corresponds to a zero data value for the current range. FIG. 6B depicts the control 602 as moved to a different location, effectively filtering out entities associated with histogram bar 604 (now grayed). FIG. 6C depicts the control 602 as moved backed to the initial location of FIG. 6A. Control 606 has been moved to new location, effectively filtering out a number of entities associated with data values greater than about 11,500 for this example. Histogram bar 604 has been re-filled to correspond with the color gradient and is now partially hatched to indicate that the data value range is also filtered by a different filter.

FIGS. 7A-7B depict examples of a visualization interface 700 including a treemap representation 702 and visual control features. As shown in FIG. 7A, treemap fields are rendered in the colors defined by a horizontal color gradient 704, and endpoints 706 and 708. As shown in FIG. 7B, as the left slider is moved to redefine endpoint 706, corresponding treemap fields are rendered in new colors defined by the horizontal color gradient 704, and the potential new location of endpoint 706. As shown, histogram element 710 is now grayed and associated treemap elements (shown collectively by outline 712) are fading to gray in the treemap representation 702 to dynamically provide visual filter effects to an end-user.

While a number of examples and embodiment are described above, other embodiments and examples are available. In one embodiment, a visualization control interface can be notified about changes based on a server side integration component trigger event (e.g., the OnFindRecord) and implement a subsequent trigger (e.g., OnNextRecord trigger). When changes are made to adjustable aspects of a visualization control interface, new XML data can be generated for a treemap visualization. For example, a visualization application can use a codeunit having a MakeTreeMapXmlData method which can be used on a table and a Treemap Data Builder COM object to build valid Treemap XML data.

The MakeTreeMapXmlData method can optionally collect information about all fields in a table or only fields of certain characteristics, for example numerical fields like of type Decimal, and include this information in the Treemap XML data. The visualization application uses the information to populate the field selectors (e.g., drop down) for size and color measures. A page that calls the MakeTreeMapXmlData method sends the setup information only once when it initializes the page. The MakeTreeMapXmlData method also adds the values for the two referenced fields of all rows in the table to the XML. In one embodiment, a control add-in combines optional setup information and data to show in one XML data stream that is sent to the visualization control.

A visualization interface can be configured to allow single selection of individual treemap fields using a selection marker to mark a selected field. For example, if user clicks on a field, the field gets selected and the selection marker is moved to the clicked field. Key-Arrow keys can be used to cycle a selection within the treemap visualization. While using the arrow keys, the focus will never leave the treemap. If the selection has arrived at a border of the treemap it will cycle to the opposite border and continue from that point. A TAB key can be used to move a selection to the next treemap field in the Tab order (not necessarily lying next to the currently selected one) and the focus will eventually leave the treemap.

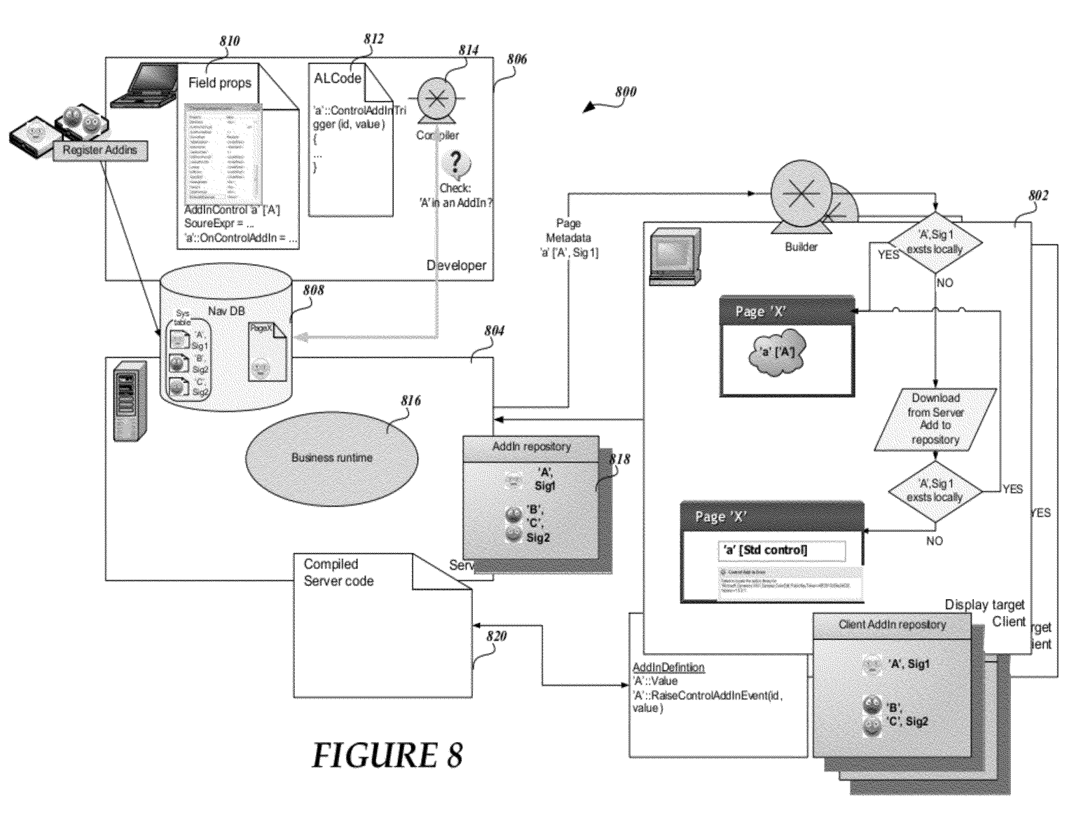

FIG. 8 depicts a functional block diagram of exemplary computing environment 800 including client, server, and developer components used in part to provide data visualization features. The client 802, server 804, and developer component 806 are used to provide interactive treemap visualizations. As shown for the exemplary environment 800, the developer component 806 provides register add-ins to the database 808.

The developer component 806 of one embodiment defines field properties 810, application language code or logic 812, and compiler 814 used in part to compile add-in compatibility with server 804. As shown, database 808 includes sys table and at least one page (Page X). The server 804 of one embodiment includes a business runtime 816, an AddIn repository 818, and compiled code 820, but is not so limited. The client 802 of one embodiment includes client AddIn repository 822 and AddInDefinition component 824, but is not so limited. As shown, Page ‘X’ data structure is populated using local content if it exists; otherwise the client displays an error to download the add-in code.

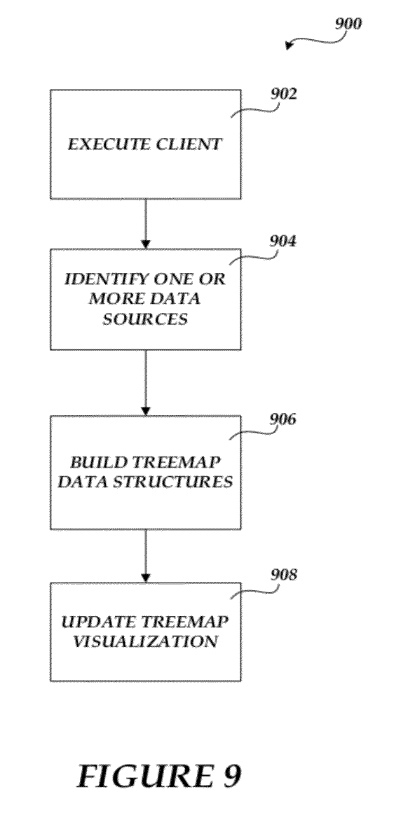

FIG. 9 is a flow diagram illustrating an exemplary process 900 of providing a treemap data visualization including visual control and attention garnering/attracting features, but is not so limited. At 902, the process 900 begins when a client application is executed that includes providing an interactive visualization interface that includes a portion to render a treemap representation and a number of visual controls. For example, the client can integrate with a server-based resource planning application to provide visualization features for use in ascertaining trends and outliers associated with complex data sets. At 904, the process 900 operates to identify one or more data sources containing data to be used to populate visualization data structures. For example, a client user can select or a server role may require use of one or more data sources when visualizing a treemap data structure.

At 906, the process 900 builds treemap data structures based in part on the selected data source or sources, a number of visualization measures, and/or visual filter control settings and/or inputs. For example, as part of using a visualization interface, the user may select a profit measure and a sales measure as metrics of a treemap visualization display, and thereafter using visual filter controls to adjust color filter parameters and/or size filter parameters to ascertain trends and important parts of a treemap visualization animation. At 908, the process 900 operates to update a treemap visualization based in part on changes to underlying data sources and/or resulting from visual filter control adjustments. For example, a customer database may be updated periodically with data changes which need to be incorporated into the treemap visualization or a user may adjust color and/or size range filters to dynamically adjust and transition elements of the treemap visualization.

In one embodiment, the process 900 uses integrated histogram and visual range filtering control inputs to provide visualization changes as part of user interactions and inputs. For example, a user can use adjustable boundary controls (e.g., slider elements) to determine range endpoint values and the position of the range within the overall range of data to use for a treemap visualization. Elements of a treemap visualization can be rendered to dynamically fade in, fade-out, increase in size, decrease in size, etc. as boundaries of a range filter change over the value range.

The control inputs can be used by the process 900 to smoothly transition visualization displays in response to user control, including responsively changing color and/or size parameters of treemap elements contained within a treemap visualization display. For example, coloring and hatching effects can be cooperatively tied and dynamically updated between displayed treemap elements and histogram bars as a user slides and redefines a data boundary to highlight data portions that identify relevant aspects of a particular company asset according to select display measures (e.g., profit, loss, gain, orders, sales, etc.). While a certain number and order of operations is described for the exemplary flow of FIG. 9, it will be appreciated that other numbers and/or orders can be used according to desired implementations and other embodiments are available.

While certain embodiments are described herein, other embodiments are available, and the described embodiments should not be used to limit the claims. Exemplary communication environments for the various embodiments can include the use of secure networks, unsecure networks, hybrid networks, and/or some other network or combination of networks. By way of example, and not limitation, the environment can include wired media such as a wired network or direct-wired connection, and/or wireless media such as acoustic, radio frequency (RF), infrared, and/or other wired and/or wireless media and components. In addition to computing systems, devices, etc., various embodiments can be implemented as a computer process (e.g., a method), an article of manufacture, such as a computer program product or computer readable media, computer readable storage medium, and/or as part of various communication architectures.

The term computer readable media as used herein may include computer storage media. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e., memory storage.). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of device.

The term computer readable media as used herein may also include communication media. Communication media may be embodied by computer readable instructions, data structures, program modules, or other data in a modulated data signal, such as a carrier wave or other transport mechanism, and includes any information delivery media. A modulated data signal may describe a signal that has one or more characteristics set or changed in such a manner as to encode information in the signal. By way of example, and not limitation, communication media may include wired media such as a wired network or direct-wired connection, and wireless media such as acoustic, RF, infrared, and other wireless media.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components include, but are not limited to, wide area networks (WANs), local area networks (LANs), metropolitan area networks (MANs), proprietary networks, backend networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions. Other embodiments and configurations are available.

### Exemplary Operating Environment

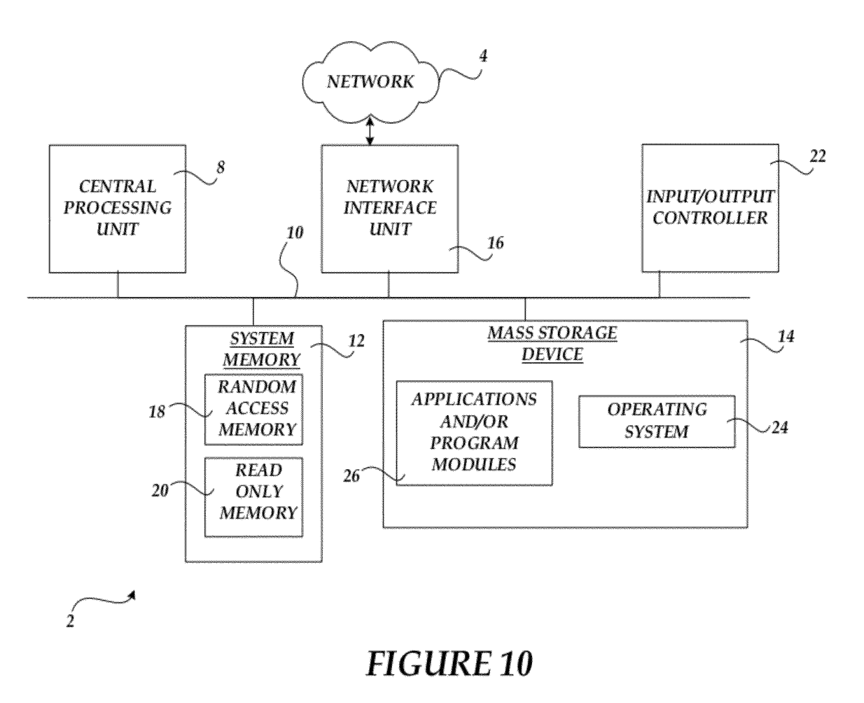

Referring now to FIG. 10, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 10, an illustrative operating environment for embodiments of the invention will be described. As shown in FIG. 10, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules 26.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method of visualizing data comprising:
using one or more data sources that include data as part of providing a visualization interface;
providing a treemap representation as part of the visualization interface;
providing a first visual control interface that includes a first adjustable boundary control and a second adjustable boundary control used in part to control a first aspect of the treemap representation;
providing a second visual control interface that includes a first adjustable boundary control and a second adjustable boundary control to control a second aspect of the treemap representation; and
displaying aspects of the treemap representation based in part on visualization settings associated with the first visual control interface and the second visual control interface.

2. The method of claim 1, further comprising controlling the aspects of the treemap representation based in part on positioning the first adjustable boundary control of the first visual control interface from a first position to a second position to define a lower range boundary of a color spectrum for treemap element representations.

3. The method of claim 2, further comprising controlling the aspects of the treemap representation based in part on positioning the second adjustable boundary control of the first visual control interface from a first position to a second position to define an upper range boundary of the color spectrum for the treemap element representations.

4. The method of claim 1, further comprising controlling the aspects of the treemap representation based in part on positioning the first adjustable boundary control of the second visual control interface from a first position to a second position to define a lower range boundary of a size spectrum for treemap elements.

5. The method of claim 4, further comprising controlling the aspects of the treemap representation based in part on positioning the second adjustable boundary control of the second visual control interface from a first position to a second position to thereby define an upper range boundary of the size spectrum for the treemap elements.

6. The method of claim 1, further comprising providing the first visual control interface to include histogram based visual range filtering features that include measures of a color spectrum and a histogram representation including representative bars and value indicators to indicate a number of associated treemap elements associated with each representative bar.

7. The method of claim 6, further comprising updating a color gradient for the representative bars of the histogram as part of adjusting a color value range of defined treemap values using the first visual control interface.

8. The method of claim 1, further comprising providing the second visual control interface to include histogram based visual range filtering features that include measures of a size spectrum and a histogram representation including representative bars and value indicators to indicate a number of associated treemap elements associated with each representative bar.

9. The method of claim 8, further comprising updating sizes of the representative bars of the histogram as part of adjusting a size range of defined treemap values using the second visual control interface.

10. The method of claim 1, further comprising using the treemap representation to examine aspects of business data including providing cross-hatching representations to delineate portions of histogram bars filtered out by a different visual control interface.

11. The method of claim 1, further comprising displaying the treemap representation based in part on changes to a visualization range defined in part by settings of a color range filter including transitioning one or more treemap elements from a first color to a second color while displaying the treemap representation.

12. The method of claim 1, further comprising displaying the treemap representation based in part on changes to a visualization range defined in part by settings of the size range filter including transitioning one or more sizes of one or more treemap elements while displaying the treemap representation.

13. The method of claim 1, further comprising implementing the first visual control interface as a first visual filter and the second control interface as a second visual control filter and displaying the treemap representation based in part on changes to visualization ranges defined in part by settings of the first visual filter and the second visual filter including transitioning one or more treemap elements using color and size representations.

14. The method of claim 1, further comprising displaying the treemap representation and highlighting outlier-values as part of identifying a proportional impact of a first measure controlled by the first visual control interface and a second measure controlled by the second visual control interface including dynamically animating visualization elements to be hidden or shown.

15. A system comprising:
processing and memory resources used in part to render a treemap representation of data including dynamically rendering treemap elements;
a number of data sources including enterprise data and other information to populate a treemap data structure corresponding to the treemap representation;
a visualization component to provide the treemap representation including using first visual filter settings to define a first visualization aspect of the treemap representation based in part on a first measure of the data and second visual filter settings to define a second visualization aspect of the treemap representation based in part on a second measure of the data; and
a display component to display the treemap representation based in part on the first and second visual filter settings.

16. The system of claim 15, further comprising a histogram-based color control interface to dynamically control renderings of treemap field regions using a range of colors and a linear color gradient.

17. The system of claim 15, further comprising a histogram-based size control interface to dynamically control renderings of treemap field regions using a range of sizes and corresponding value ranges.

18. A computer implemented visualization interface comprising:
a treemap interface that includes a plurality of treemap fields having size features and color features;
a first adjustable visual filter including a range of size settings to control the size features of one or more treemap fields according to a first measure of data, wherein each size represents a range of values associated with a first visual range to control presentation of the one or more treemap fields;
a second adjustable visual filter including a range of color settings to control the color features of one or more treemap fields according to a second measure of data, wherein each color represents a range of values associated with a second visual range to control presentation of the one or more treemap fields; and
a detail pane to provide entity details for a select treemap field.

19. The visualization interface of claim 18, further comprising selection controls to select a first type of measure and a second type of measure as part of providing a visualization of data, wherein each field of the treemap interface includes one of a color and size as controlled by the first and second adjustable visual filters.

20. The visualization interface of claim 18, wherein the first and second adjustable visual filters are disposed adjacent to the treemap interface and used to adjust a selection of data for color and a selection of data for size adjustments including displaying a color legend with a color measure selector that includes a full color range for data values that occur in a visualized data set.
